(19) United States
(12) Patent Application Publication
(10) Pub. No.: US 2013/0048669 A1
(43) Pub. Date: Feb. 28, 2013

(54) BOILING WATER DISPENSER

(71) Applicants: Theodoor Stolk, Drachten (NL); Jacqueline Van Driel, Drachten (NL); Klaas Kooijker, Drachten (NL)

(72) Inventors: Theodoor Stolk, Drachten (NL); Jacqueline Van Driel, Drachten (NL); Klaas Kooijker, Drachten (NL)

(73) Assignee: KONINKLIJKE PHILIPS ELECTRONICS N.V., EINDHOVEN (NL)

(21) Appl. No.: 13/639,661

(22) PCT Filed: May 9, 2011
(86) PCT No.: PCT/IB11/52035

§ 371 Date: Oct. 5, 2012

(30) Foreign Application Priority Data
May 20, 2010 (EP) 10163410.3

(51) Int. Cl. B67D 7/82

(52) U.S. Cl. 222/52; 222/146.2; 222/113

(57) ABSTRACT

A boiling water dispenser (1) is disclosed comprising a water inlet (2) and a water outlet (7) between which a flow path (11) exists. In this flow path a heating device (4) is arranged to heat water flowing through the flow path (11). Further, the flow path comprises a pump (3) arranged to pump water from the water inlet (2) to the heating device (4) in a streaming direction through the flow path (11). A first restrictor element is (5) placed downstream of the heating device (4) in said flow path (11), creating an overpressure in said heating device (4). Also, the boiling water dispenser (1) comprises a hot water reservoir (15) downstream of the first restrictor element (5) in said flow path (11), wherein said hot water reservoir (15) is arranged to allow gaseous water to separate from liquid water. The hot water reservoir (15) has a hot water reservoir inlet opening (17) and a hot water reservoir outlet opening (18), wherein the part of the flow path (11) from the hot water reservoir outlet opening (18) to the water outlet (7) is arranged to cause, during use, a build-up of some water in the hot water reservoir (15). Water flowing from this boiling water dispenser (1) will flow out of the water outlet (7) in a well defined manner without sputtering. This makes this boiling water dispenser especially user friendly and safe to use.

### FIELD OF THE INVENTION

The invention relates to a boiling water dispenser comprising a water inlet, a water outlet, a flow path connecting the water inlet to the water outlet, a heating device arranged to heat water flowing through the flow path, a pump arranged to pump water from the water inlet to the heating device in a streaming direction through said flow path, and a first restrictor element placed downstream of the heating device in said flow path, whereby the first restrictor element is arranged to create an overpressure in said heating device.

### BACKGROUND OF THE INVENTION

Many devices are known which are arranged to heat water and to dispense heated or even boiling water. An example of such a device is disclosed by WO 2009/151321 A2. The hot water system disclosed in this patent document has a tank in which water is heated. This water can be discharged through a discharge pipe when a tap is opened. WO 2009/151321 A2 discloses that the tank of its device is arranged to hold water of temperatures around 110° C. at a pressure higher than the atmospheric pressure. On opening of the tap the hot water will start to flow out. Water exiting the tap will experience a pressure drop to atmospheric pressure. As the temperature of the water is above the atmospheric boiling point, the out flowing water will exhibit boiling characteristics like the presence of both liquid and gaseous water. At the tap exit this will cause sputtering of the hot water. The sputtering of the hot water exiting the tab is a problem of the device disclosed by WO 2009/151321 A2 as sputtering hot water can be dangerous for a user who holds a cup near the tap exit, e.g. while wanting to fill said cup with boiling water to make tea, instant soup or another treat. Especially the hands holding said cup are in danger of being hit by sputtering hot, boiling water. This can cause the user to experience pain, or, in more severe situations, cause burns on the user's hands. Further, the sputtering of the boiling water exiting the tap leads to spoiling precious heated water. Even further, the sputtering might cause problems in filling a cup or other type of container with a narrow fill opening.

A further example of a device arranged to heat water and to dispense the heated water is disclosed by EP 1462040 A1. This patent document discloses an installation for the preparation of hot water comprising a flow through heating unit in which water is heated to a temperature just below 100° C. The installation of EP 1462040 A1 is an open system in which 100° C. is the boiling temperature of water. Consequently the installation of EP 1462040 A1 cannot deliver boiling water, but hot water only. By heating the water to a temperature just below 100° C. it is prevented that a high amount of bubbles is formed in the heating unit. It is widely known that gaseous water has a different heat absorption rate than liquid water. This difference is known to lead to local overheating of heating elements in which a high amount of gaseous water is formed. Local overheating is a known cause for heater failure. This is especially a problem when the flow through heater is to be operated continuously for a sustained period.

### SUMMARY OF THE INVENTION

It is an object of the invention to provide a boiling water dispenser from which the water flows without sputtering.

The object of the invention is realized by the boiling water dispenser as defined in claim 1. Particularly, the boiling water dispenser according to the invention comprises a hot water reservoir downstream of the first restrictor in said flow path, wherein said hot water reservoir is arranged to allow gaseous water to separate from liquid water, said hot water reservoir having a hot water reservoir inlet opening and a hot water reservoir outlet opening, wherein the part of the flow path from the hot water reservoir outlet opening to the water outlet is arranged to cause, during use, a build-up of some water in the hot water reservoir.

The boiling water dispenser of the invention is connected to some water supply via the water inlet. This water supply might be a mains water supply, a separate water reservoir or any other type of water supply suitable for the purpose of feeding water to the boiling water dispenser. During use of the boiling water dispenser according to the invention, water will flow in a streaming direction from the water inlet to the water outlet via a flow path under the influence of the operation of a pump. This can be any type of pumps suited for pumping the required flow rate. This types of pump are generally known and do not form part of the invention. Typically, the water temperature at the water inlet is much lower than the water temperature at the water outlet. The water temperature at the water inlet might e.g. between 15° C. and 25° C. Other input values are possible as well. While flowing from the water inlet to the water outlet, the water passes downstream of the pump a heating device arranged to heat said water. Downstream of the heating device a first restrictor element is placed in the flow path. Restrictor elements are widely known in relation to fluid transportation systems. The person skilled in the art will therefore select a suitable restrictor element for the situation at hand. The criteria are to be further specified below. It is well known that when placed in series, a pump and a restrictor element will cause an overpressure in the flow path between the pump and the restrictor element. An overpressure is to be understood in this context as being a pressure higher than the pressure that would be prevalent in the absence of the restrictor element. The amount of overpressure is dependent on both the characteristics of the pump as well as on the characteristics of the restrictor element. The over pressure generated between the pump and the first restrictor element in the boiling water dispenser of the invention is present in the heating device as well as this device is placed between the pump and the first restrictor element. It is common general knowledge that the boiling temperature, or boiling point, of water, and more generally of any fluid, is a function of the pressure. Generally speaking, the boiling temperature of water will increase with increasing pressure. As a consequence of the increased pressure in the heating device caused by the combination of the pump and the first restrictor element the water in the heating device can be heated to temperatures above the ambient boiling temperature without boiling to occur. The ambient boiling temperature is considered to be the boiling temperature of water at ambient pressure, thus without the pressure increase caused by the pump and first restrictor combination.

The heating device of the boiling water dispenser of the invention is dimensioned such that the water flowing along the flow path is heated to a desired temperature. Such dimensioning is considered well-known to a person skilled in the art and is not detailed further, nor considered as part of the invention. The heating device might comprise control logic to regulate the heating device behavior based on the actual water temperature flowing out of the heating device and a desired temperature of the water flowing out of the heating device. Alternatively, or in addition, the heating device might comprise control logic regulating the heating device behavior based on the temperature of the water flowing into the heating device. In other embodiments, the heating device might be designed to operate without control logic.

The heated water passing the first restrictor element will experience, due to the first restrictor element, a drop in pressure. The water having flowed past the first restrictor element will thus have a lower boiling temperature. In advantageous embodiments the water flowing out of the heating device will have a temperature below the boiling point of water given the pressure in the heating device, but at the same time a temperature above the boiling temperature at the pressure being prevalent after the first restrictor element. Following generally known laws of physics the heated water which passed the first restrictor element will start to boil and its temperature will drop to the boiling temperature of water at the prevailing pressure. The boiling water will contain a mixture of gaseous and liquid water. The boiling water will flow into a hot water reservoir. This hot water reservoir allows the gaseous and liquid phases of the boiling water to separate. The part of the flow path from the hot water reservoir outlet opening to the water outlet is arranged to cause, during use, a build-up of some water in the hot water reservoir. Due to this build-up the flow-through time of the water from the hot water reservoir inlet opening to the hot water reservoir outlet opening is increased, allowing the separation of the gaseous and liquid phases of water to take place more efficiently.

In a practical embodiment, the part of the flow path from the hot water reservoir outlet opening to the water outlet may have a larger diameter than the first restrictor element.

In a practical embodiment, a further restrictor element is placed between the hot water reservoir outlet opening and the water outlet.

In another practical embodiment, the water outlet might be positioned above the hot water reservoir outlet opening when seen in the field of gravity, thus the water flowing through flow path between the hot water reservoir outlet opening and the water outlet having to overcome the force of gravity.

The fluid phase of the water at boiling temperature flows from the hot water reservoir to the water outlet via a further restrictor element. The hot water will flow from the boiling water dispenser device and can be used by a user to e.g. make a tasty hot beverage. As only the liquid phase of the water flows through the water outlet no sputtering will occur. In other words, the separation of the liquid and gaseous phases of the hot water which takes place in the hot water reservoir leads to a controlled outflow of the water from the boiling water dispenser, making the boiling water dispenser according to the invention user friendly and safe to use. It is to be understood that the hot water being dispensed will be at or near the boiling temperature of the water given the ambient pressure. Near the boiling temperature can be anywhere between 90% and 100% of the boiling temperature at the ambient pressure.

It is to be understood that various ways of operation of the device are possible. For example, a boiling water dispenser according to the invention might be operated by a user by pushing one button only. Said button will activate the heating device while a control circuit containing a sensor is arranged to measure the temperature of the water in the heater. When a predetermined temperature is reached the pump may be started to commence the flow of water through the flow path. In alternative embodiments a boiling water dispenser according to the invention might have two control buttons. A first button might be arranged to allow a user to switch on the heating device. A second button might be arranged to allow the user to switch on the pump. In such embodiments a user interface might be provided to indicate to the user that the water in the heating device is sufficiently heated to start the pump and have boiling water flowing out of the water outlet. Even further ways of operation are feasible as well.

Another advantage of the boiling water dispenser according to the invention is that the user can dose the amount of water to be heated quite precisely. This prevents the heating of superfluous amounts of water as often occurs in traditional water kettles.

In a preferred embodiment of the boiling water dispenser according to the invention, the first restrictor element is arranged to create an overpressure in the heating device of approximately 1.4 bar during continuous operation. Approximately 1.4 bar is understood to be between 1.2 bar and 1.6 bar. It appeared to the inventors of the present invention that this overpressure can easily be accommodated in a domestic appliance without requiring expensive safety measures, while at the same time it causes a sufficiently increase of the pressure in the heating device to allow the water to be heated to a temperature as detailed above.

In the boiling water dispenser according to the invention the heating device is arranged to heat the water to a temperature near its boiling temperature, preferably to a temperature between 90% and 98%, even more preferably to a temperature between 93% and 95% of its boiling temperature. In heating devices arranged to heat water to or near its boiling temperate a drop in heat transmission from the heating device to the water occurs when the water is boiling, that is when gaseous water develops in such amounts that the gaseous water cannot dissolve in the liquid water. It is to be noted that shortly before this boiling commences, small bubbles of gaseous water are formed at the interface between the heating device and the water. These small bubbles quickly dissolve in the water. As is commonly known from physics, heat is much better transmitted from a heat source to liquid water than to gaseous water. A hot heating device not being able to transmit its heat to the water might suffer from overheating. Such overheating might lead to damage to the heating device and even to malfunction of the entire boiling water dispenser. To prevent gaseous water to develop it was found by the inventors that it is advantageous to heat the water in the heating device to a value between 90% and 98% of the boiling temperature at the pressure in the heating device. The upper bound of this range is to be chosen close to the boiling temperature while still allowing local variations in the temperature of the water in the heating device not leading to the development of gaseous water to an extend that might damage the heating device. On the other hand, the lower bound of this range is to be chosen such that the water will be at boiling point after passing the first restrictor element. It was found that an even more reliable operation of the boiling water dispenser can be achieved when the water is heated in the heating device to a temperature between 93% and 95% of its boiling temperature at the pressure in the heating device.

In a preferred embodiment of the boiling water dispenser according to the invention a flow guide is placed between a hot water reservoir inlet opening and a hot water reservoir outlet opening, said flow guide being arranged to prevent a direct flow of the water from the hot water reservoir inlet opening to the hot water reservoir outlet opening. This flow guide delays the flow of water from the hot water reservoir inlet opening to the hot water reservoir outlet opening, thereby allowing the gaseous and the liquid phases of the boiling water to separate. This ensures that only liquid water flows out of the hot water outlet opening and consequently from the water outlet as well.

In a preferred embodiment the flow guide is perforated.

In a preferred embodiment of the boiling water dispenser according to the invention the dispenser further comprises a cold water reservoir, said cold water reservoir being fluidly connected to the water inlet. A cold water reservoir offers the option to utilize the boiling water dispenser at locations at which no water mains outlet connector is available. In most homes a water mains connector or tap is only available at some locations. It is highly beneficial when the boiling water dispenser according to the invention can be used on other locations as well. This is achieved by having a cold water reservoir in fluid connection to the water inlet. Water can be stored in the cold water reservoir before use of the device. The cold water reservoir can be either releasably attached to the boiling water dispenser or fixedly attached. After water is stored in the cold water reservoir, the boiling water dispenser can be used at any location irrespective of the availability of a connection to water mains.

In a preferred embodiment of the boiling water dispenser according to the invention the hot water reservoir has an overflow exit. The hot water reservoir is located before the further restrictor element. As a consequence there will be a build-up of water near or at its boiling temperature in the hot water reservoir. Similar to above, near the boiling temperature can be anywhere between 90% and 100% of the boiling temperature at the pressure prevalent in the hot water reservoir. When the water outlet is blocked for whichever reason while the pump is operating, the hot water reservoir will fill up with boiling water. The hot water reservoir overflow prevents the situation that the water in the flow path stops flowing while the heating device is still in operation. Without the hot water reservoir overflow the water in the heating device would get to boil, the gaseous water causing a quick rise in pressure in the flow path. This quick pressure rise can cause damage to one or more elements in the flow path. A hot water reservoir overflow prevents such possibly dangerous damage.

In a preferred embodiment of the boiling water dispenser according to the invention the hot water reservoir overflow exit is fluidly connected to the cold water reservoir. Potentially, the water flowing from the hot water reservoir overflow is at or near its boiling point. Water of this temperature is potentially dangerous to the user as it can lead to serious burns. Therefore it should be prevented that the water exiting the hot water reservoir through the overflow can get into contact with the user. By connecting the hot water reservoir overflow to the cold water reservoir in a closed flow path manner, a flow path is created which prevents hot water to exit from the boiling water dispenser at another location than the water outlet.

In a preferred embodiment of the boiling water dispenser according to the invention the hot water reservoir has an at least partly translucent or transparent housing such that the water can be observed from outside the dispenser. In alternative embodiments the hot water reservoir has an at least partly transparent housing. By observing the water in the hot water reservoir the user can easily check the correct operation of the boiling water dispenser. As the water flowing from the water outlet contains no bubbles or other traces of gaseous water typical to the boiling of water the user will not be able to judge the correct functioning of the boiling water dispenser. As explained above, following the first restrictor the water will contain a mixture of both the gaseous and the liquid form of water typical for boiling. This mixture flows into the hot water reservoir. By allowing the user to observe the water in the hot water reservoir the user can observe the mixture of gaseous and liquid water and convince herself or himself of the correct functioning of the boiling water dispenser to the extent that the water flowing into the hot water reservoir is indeed boiling.

In a preferred embodiment of the boiling water dispenser according to the invention the boiling water dispenser further comprises a light source, wherein said light source is arranged to light the hot water reservoir. The light from the light source makes it even easier for the user to observe the mixture of gaseous and liquid water in the hot water reservoir. This improves the ease of use of the boiling water dispenser.

In a preferred embodiment of the boiling water dispenser according to the invention the heating device is a flow through heater. The application of a flow through heater significantly reduces the design constraints relating to volume or size of the boiling water dispenser.

In a preferred embodiment of the boiling water dispenser according to the invention the dispenser is arranged to empty the warm water after use. A user starting the operation of the boiling water dispenser is to be presented water of the expected temperature right from the moment the dispenser starts dispensing water. As the heating device is not at the end of the flow path but in between the pump and the first restrictor element any water that is present in the flow path between the heating device and the water outflow before the start of the operation of the dispenser will not be heated by heating device and be below the desired temperature when flowing from the water outflow. It is therefore advantageous if the water present in the flow path following the heating device is emptied from the boiling water dispenser after use.

In a preferred embodiment of the boiling water dispenser according to the invention the hot water reservoir contains an open connection with the ambient atmosphere such that no under-pressure can exist in the hot water reservoir. This is a very cheap and convenient way to realize a boiling water dispenser emptying after use.

In a preferred embodiment of the boiling water dispenser according to the invention the height of the hot water reservoir is higher than the equilibrium water height in said reservoir during use. Due to the further restrictor element the amount of water in the hot water reservoir will increase from the start of the operation of the boiling water dispenser. Having a water reservoir of sufficient height will prevent the loss of substantial amounts of boiling water through the hot water reservoir overflow or prevent a hot water reservoir without overflow to become completely filled causing dangerous situations. In such completely filled situations the flow path will be obstructed and the water in the heating device would get to boil. The gaseous water caused by this boiling leads to a quick rise in pressure in the flow path. This quick pressure rise can cause damage to one or more elements in the flow path. A hot water reservoir of sufficient height, which is a hot water reservoir being higher than the equilibrium water height, will ensure safe and efficient operation of the boiling water dispenser.

When using elementary physics, the equilibrium water height can be calculated rather straightforwardly. It is known that the hydrostatic pressure at the bottom outlet of a water column is given by P=ρgh wherein ρ denotes the density of the water, g the gravitational constant and h the height of the water column. At the same time it is generally known that said pressure results in an outflow velocity of v=√(2 gh), which outflow velocity can also be expressed as v=Q/A wherein A is the surface area of the outflow opening and Q the flow rate. In an equilibrium state the inflow and the outflow of the hot water reservoir are equal. This inflow is closely related to the flow rate caused by operation of the pump and thus known. Combining the equations it is found that the equilibrium height of the water in the boiling water reservoir can be expressed as h_{eq}=Q²ₚᵤₘₚ(2 gA²).

In a preferred embodiment of the boiling water dispenser according to the invention the dispenser further comprises a flow meter arranged to measure the flow of water through the flow path, and a control unit arranged to control the pump based on at least the flow rate as measured by the flow meter, wherein the flow meter is located in the flow path between the water inlet and the hot water reservoir inlet opening. By controlling the flow rate caused by the pump it is ensured that during operation of the boiling water dispenser the actual conditions are similar to those assumed during the design leading to an even better and more reliable performance of the boiling water dispenser. This is especially important with respect to the pressure in the heating device which is dependent on the flow rate, as well as the equilibrium height of the water column in the hot water reservoir which also depends on the flow rate generated by the pump.

With reference to the claims it is noted that the invention also relates to all possible combinations of features and/or measures defined in the various claims.

### BRIEF DESCRIPTION OF THE DRAWING

A detailed description of the invention is provided below. The description is provided by way of a non-limiting example to be read with reference to the drawing in which:

FIG. 1 shows a schematic view of a first embodiment of a boiling water dispenser according to the invention.

### DETAILED DESCRIPTION OF THE EMBODIMENTS

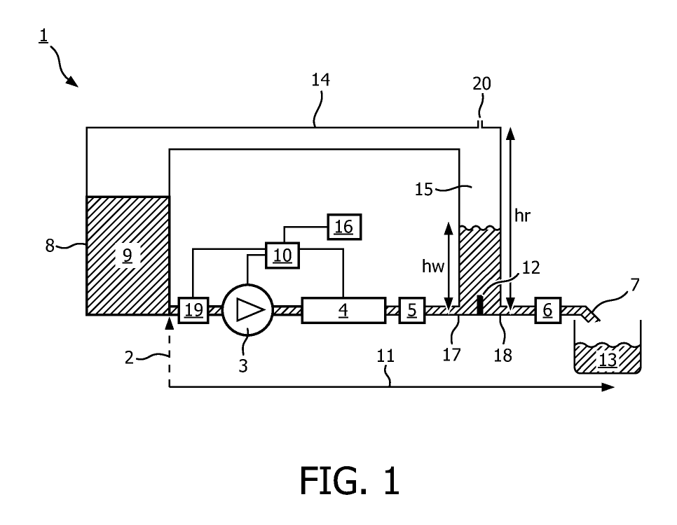

FIG. 1 schematically shows a boiling water dispenser 1 according to the invention. A cold water reservoir 8 holds an amount of cold water 9. The cold water reservoir 8 is fluidly connected to a water inlet 2. Water inlet 2 is the start of a series of elements, being fluidly connected, forming a flow path 11. This flow path 11 further contains a pump 3, a heating device 4, a first restrictor element 5, a hot water reservoir 15, a further restrictor element 6 and a water outlet 7. These elements starting from the water inlet 2 until the water outlet 7 together form the core of the boiling water dispenser. During operation of the boiling water dispenser 1 the pump 3 is engaged to pump water along the flow path towards the water outlet 7. From the water outlet 7 the boiling water will flow into a container or cup 13. The pump 3 is controlled via a control unit 10 which is connected to a user interface element 16 capable of receiving user input, to flow meter 19, and to the heating device 4. The hot water reservoir 15 further contains an inlet opening 17 and an outlet opening 18. A flow guide 12 is placed between the inlet opening 17 and the outlet opening 18. Further, the hot water reservoir 15 has an overflow 14 which is fluidly connected to the cold water reservoir 9.

A user desiring to utilize the boiling water dispenser 1 will fill cold water reservoir with water 9. In alternative embodiments the boiling water dispenser might not have a cold water reservoir. Instead, the boiling water dispenser might be connected to the water mains directly. A boiling water dispenser having a cold water reservoir is however more user friendly as it can be used at locations without a water mains connection point as well. The cold water reservoir 8 can be either fixedly or releasably connected to the boiling water dispenser 1. The user will fill the cold water reservoir 8 having the amount of needed boiling water in mind. However, this is not critical as will be explained later. Following the filling of the cold water reservoir 8, the amount of cold water 9 in the cold water reservoir 8 will be at least the amount of boiling water required. However, if the amount of cold water does not suffice, the cold water reservoir could be refilled and the dispensing of boiling water continued in a second round of operation of the boiling water dispenser 1. As might be the case, the cold water reservoir 8 might still contain water 9 from an earlier use of the boiling water dispenser 1 and no filling of the cold water reservoir 8 is necessary.

The user will instruct the boiling water dispenser 1 to start operating by engaging with the user interface element 16. This user interface element 16 can be any device able to receive user input and, in some embodiments, to feed information on the operation of the boiling water dispenser 1 back to the user. The user input can be received by the user interface element 16 e.g. by the registering of the actuation of a switch or touch of a touch sensitive area by the user. The user interface element 16 might also be used by the user to indicate a desire to end the operation of the boiling water dispenser 1. Alternatively, the operation of the boiling water dispenser 1 might be terminated after a predetermined amount of water has been heated. In some embodiments the user might select the amount of water to be heated. The user interface element 16 transmits a signal reflecting the user input to the control unit 10. The control unit 10 will prompt the pump 3 to start pumping and the heating device 4 to start heating. Under influence of the pump 3, water will start to flow from the water inlet 2 in the direction of the water outlet 7 along the flow path. The water will be heated in the heating device 4. The first restrictor element 5 which is positioned after the heating device 4 when seen in the direction of the flow of the water will cause an overpressure to be present between the pump 3 and the first restrictor element 5. Thus, this overpressure will also be present in the heating device 4. This method of creating an overpressure is well known in the art. In this embodiment a flow meter 19 is paced before the pump 3. The flow meter 19 is connected to the control unit 10 and arranged to communicate the flow rate of the water flowing along the flow path 11 to the control unit 10. Control unit 10 can regulate the pump 3 based on the measured flow rate to obtain a predetermined flow rate in the boiling water dispenser 1. By controlling the pump 3 the flow rate through the system is well-defined. Consequently the overpressure between the pump 3 and the first restrictor element 5 is well-defined as well, allowing optimal operation of the boiling water dispenser 1. As will be explained later, the flow rate generated by pump 3 is also of importance to the dimensioning of the hot water reservoir 15. By controlling pump 3 to generate a predetermined flow rate it is guaranteed that the water reservoir 15 being designed for the predetermined flow rate meets the requirements during actual use. In alternative embodiments, the flow meter 9 might be omitted. The heating device 4 is dimensioned such that the water is heated to a temperature higher than the boiling temperature of water at the ambient pressure prevailing outside the boiling water dispenser 1. As the water in the heating device 4 is under some higher pressure, as explained before the water in the heating device 4 experiences the overpressure caused by the combination of the pump 3 and the first restrictor element 5, the boiling temperature of the water in the heating device 4 will be higher. This change in boiling temperature is governed by well known laws of physics and not detailed further. In advantageous embodiments the heating device 4 on the one hand and the combination of the pump 3 and the first restrictor element 5 is chosen such that the overpressure prevalent in the heating device 4 is approximately 1.4 bar, thus the absolute pressure being 2.4 bar. At the same time the water is heated by the heating device 4 to a temperature between approximately 105° C. and 120° C. which is somewhat below the boiling temperature of water at an absolute pressure of 2.4 bar of approximately 126° C. It should be noted that in other embodiments other pressures and temperatures can be realized without digressing from the invention. It is also to be noted that in some embodiments the temperature of the water leaving the heating device 4 can depend on the temperature of water flowing into the heating device 4. It is beneficial to heat the water to a temperature below its boiling point in the heating device. During boiling gaseous water will develop which is not dissolved in the surrounding water. The heat transfer between the heating device and the gaseous water is considerably less than between the heating device and liquid water. Consequently, the temperature at the heating device surface in contact with the water will increase. This could lead to local overheating of the heating device causing failure of the heating device. Also, due to the formation of the gaseous water the pressure in the heating device will increase, leading to a burst of water towards the first restrictor element 5. It is to be noted that when the water is near boiling small bubbles will develop at the interface between the heating element 4 and the water. These small bubbles will come loose of this interface and dissolve into the surrounding water. At the temperature at which this effect occurs, the heat transfer between the heating device 4 and the water is significantly higher, as is known from the art. The heating device 4 is of the so-call flow-through type. In other embodiments other types of heating devices might be employed as well. A well known method to operate a flow through heating device like the one employed in boiling water dispenser 1 is to measure the temperature of the water flowing out of the heating device and feeding this measurement to a control device like control unit 10. When the temperature of the water flowing from the heating device rises above a predetermined threshold the heating device is turned off, which causes the temperature of the out flowing water to drop. The control unit will switch the heating device on again when the temperature of the water leaving the heating device drops below a further predetermined threshold. It should be noted that other control strategies can be implemented in other embodiments and that embodiments without a heating device control are feasible as well.

After passing the first restrictor element 5 the water will experience a drop in pressure. At this lower pressure, the boiling temperature of water is lower as well. The water being heated in the heating device 4 to a temperature between approximately 105° C. and 110° C. will be at a temperature above the boiling temperature at the prevalent pressure following the first restrictor element 5. This causes the water to start boiling while its temperature drops to the boiling temperature at the prevalent pressure. Due to the boiling of the water both gaseous and liquid water will be present. This mixture of the two water phases flows further through the flow path 11 to enter the hot water reservoir 15 via the hot water reservoir inlet opening 17. In the hot water reservoir 15 the two phases of water will separate as the gaseous water will rise towards the top of the hot water reservoir 15 while the liquid water remains towards the bottom of the hot water reservoir 15. The liquid water will leave the hot water reservoir 15 via the hot water reservoir outlet opening 18 to flow along the flow path towards a further restrictor element 6 and finally to the water outlet 7 where the liquid water leaves the boiling water dispenser 1 and might flow into a cup 13 or otherwise suitable container provided by the user in a position to capture the hot or boiling water.

In this embodiment a flow guide 12 is placed in the hot water reservoir 15 between the hot water reservoir inlet opening 17 and hot water reservoir outlet opening 18. Embodiments without such a flow guide are feasible as well. The flow guide will prevent the water to flow from the hot water reservoir inlet opening to the hot water outlet opening in a very short time by forcing the water flow to take a divert. Consequently, the water will be in the hot water reservoir 15 for some longer time than it would have been without the flow guide 12. This somewhat longer time allows the two phases of water flowing into the hot water reservoir 15 more time to separate, leading to an improved separation of said phases and attributes thereby to a good separation of both phases of water, so that liquid water only leaves the water outlet 7 even at high flow rates.

Due to the further restrictor element 6 some water will accumulate in the hot water reservoir 15 during operation of the boiling water dispenser 1. If FIG. 1 the water height is indicated by h_{w}. According to the laws of physics an equilibrium height of the water in the hot water reservoir 15 will be reached being approximately h_{eq}=Q²ₚᵤₘₚ(2 gA²), wherein h_{eq} denotes the equilibrium value of the water height h_{w}, Qₚᵤₘₚ the flow rate of the water generated by pump 3, g the gravitational constant and A the area of the opening of the further restrictor element 6. It should be noted that h_{eq} is an approximate value derived from theoretical model situations not taking into account all real life environmental aspects of the boiling water dispenser of the embodiment shown. For instance, the top of the water column in the hot water reservoir 15 will be disturbed by bubbles of gaseous water moving upwards. This makes the top of the water column somewhat hard to define. Other approximations in the theoretical model leading to the above formula will be apparent to the person skilled in the art. Although being an approximate value, h_{eq} should be taken into account while designing the height hᵣ of the hot water reservoir. In the embodiment of FIG. 1 hᵣ has been chosen to be substantially higher than the equilibrium value of the height of the water column, ensuring the hot water reservoir 15 being large enough during normal use. It is to be noted that the application of a further restrictor element 6 is one of the many ways that accumulation of some amount of boiling water in the hot water reservoir 15 can be obtained during operational use of the boiling water dispenser 1. In other embodiments other technical measures can be implemented to realize the build-up of some amount of boiling water in the boiling water reservoir. In all such embodiments it is key that the flow of water through the part of the flow path from the hot water reservoir outlet opening 18 to the water outlet opening 7 at the pressure prevalent after the first restrictor element is lower than the flow rate sustained by the pump 3. This means that initially, that is following the start of the operation of the boiling water dispenser 1, water flows into the hot water reservoir 15 at a higher flow rate than that it will leave the hot water reservoir 15. This leads to a build-up of water in the hot water reservoir 15. This build-up leads to a higher hydrostatic pressure near the hot water reservoir outlet opening 18. As discussed above, this higher pressure will lead to an increased flow through the part of the flow path from the hot water reservoir outlet opening 18 to the water outlet opening 7. Alternative embodiments might e.g. have a pipe connecting the hot water reservoir outlet opening 18 to the water outlet opening 7 of smaller diameter than a pipe connecting the first restrictor element 5 and the hot water reservoir inlet opening 17, or have a pipe with a different internal flow resistance. Other alternatives are feasible as well, such as locating the water outlet above the hot water reservoir outlet opening such that the water flowing through the boiling water dispenser has to overcome the force of gravity in the part of the flow path between the hot water reservoir outlet opening and the water outlet.

The hot water reservoir 15 further has an overflow exit 14. Other embodiments are feasible without such an overflow exit, especially in embodiments where the height of the hot water reservoir is very substantially higher that the equilibrium water height in the hot water reservoir during normal operation. In this embodiment the overflow exit 14 is fluidly connected to the cold water reservoir 8. In other embodiments this might not be the case. When for some reason, e.g. a blockade of the water outlet 7, the water cannot leave the boiling water dispenser while the pump 3 is continuing to force water towards the water outlet a buildup of water in the hot water reservoir will take place. Potentially a problem would occur if the hot water reservoir 15 would be filled completely and the flow of water through the device could be drastically reduced or even come to a standstill. Due to this reduced flow the water in the heating device will be heated to its boiling temperature causing comparatively large amounts of gaseous water to develop. These large amounts of gaseous water cause in turn a quick increase in the pressure in the boiling water dispenser flow path. This increase in pressure might lead to failure of one or more components, e.g. by the occurrence of leaks. This is potentially dangerous to the user and might lead to a complete destruction of the device. Therefore it is advantageous to have an overflow exit 14 in fluid connection with the hot water reservoir 15 as this will continue to allow hot water to flow into the hot water reservoir 15 although the water outlet 7 is blocked, or if for some other reason the hot water not able to leave the boiling water dispenser 1 while the pump 3 and/or the heating device 4 are in operation. The excessive water being allowed out of the hot water reservoir 15 via the hot water reservoir overflow exit 14. In this embodiment the hot water reservoir overflow exit 14 is in fluid connection with the cold water reservoir 8. This is not necessarily the case in other embodiments. However the configuration shown in this embodiment prevents that any hot water flowing into the hot water reservoir overflow exit 14 will leave the hot water dispenser 1 at any other location than the water outlet 7. In other embodiments the hot water reservoir overflow exit might be connected to a drain or waste pipe or to some separate overflow reservoir.

In this embodiment, the boiling water dispenser 1 has an open connection 20 with the surrounding environment. This open connection 20 causes the pressure at the top of the water column in the hot water reservoir 15 to be ambient pressure and prevents a buildup of pressure inside the hot water reservoir 15. Also, the open connection 20 allows the hot water reservoir 15 to empty after use of the boiling water dispenser 1 as the open connection 20 also prevents under-pressure to exist in the hot water reservoir 15. In alternative embodiments, the open connection 20 might be omitted.

As described above a separation of the gaseous and the liquid phases of the heated water takes place in the hot water reservoir 15, effectively removing the gaseous phase from the water that continuous along the flow path 11 towards the water outlet 7. Consequently the water flowing from the water outlet 7 contains liquid phase water only or to such an extent that the user experiences only liquid water to flow from the water outlet 7. As effectively only liquid water flows from the water outlet 7 the behavior of this water is well controlled and very predictable to the user. E.g. the water flowing from the boiling water dispenser 1 will not sputter. This makes the boiling water dispenser very user friendly and safe to operate for the user, even if the user is not an experienced user of such kind of devices.

While the invention has been illustrated and described in detail in the drawing and in the foregoing description, the illustrations and the description are to be considered illustrative or exemplary and not restrictive. The invention is not limited to the disclosed embodiments. It is noted that the boiling water dispenser according to the invention and all its components can be made by applying processes and materials known per se. In the set of claims and the description the word “comprising” does not exclude other elements and the indefinite article “a” or “an” does not exclude a plurality. Any reference signs in the claims should not be construed as limiting the scope. It is further noted that all possible combinations of features as defined in the set of claims are part of the invention.

1. Boiling water dispenser comprising
a water inlet;
a water outlet;
a flow path connecting the water inlet to the water outlet;
a heating device arranged to heat water flowing through the flow path;
a pump arranged to pump water from the water inlet to the heating device in a streaming direction through said flow path;
a first restrictor element placed downstream of the heating device in said flow path, whereby the first restrictor element is arranged to create an overpressure in said heating device with respect to the ambient pressure;
wherein the heating device is arranged to heat the water to a temperature near its boiling temperature at said overpressure such that boiling does not occur, but above the ambient boiling temperature of the water;
wherein the boiling water dispenser further comprises
a hot water reservoir downstream of the first restrictor element in said flow path;
wherein said hot water reservoir is arranged to allow gaseous water to separate from liquid water, said hot water reservoir having a hot water reservoir inlet opening and a hot water reservoir outlet opening;
wherein the part of the flow path from the hot water reservoir outlet opening to the water outlet is arranged to cause, during use, a build-up of water in the hot water reservoir.

2. The dispenser according to claim 1, comprising a further restrictor element located between the hot water reservoir outlet opening and the water outlet.

3. The dispenser according to claim 1, wherein the first restrictor element is arranged to create an overpressure in the heating device of approximately 1.4 bar during continuous operation.

4. The dispenser according to claim 1, wherein the heating device is arranged to heat the water to a temperature between 90% and 98%, even more preferably to a temperature between 93% and 95% of its boiling temperature at said overpressure.

5. The dispenser according to claim 1, wherein a flow guide is placed between a hot water reservoir inlet opening and a hot water reservoir outlet opening, said flow guide being arranged to prevent a direct flow of the water from the hot water reservoir inlet opening to the hot water reservoir outlet opening.

6. The dispenser according to claim 1, wherein the dispenser further comprises a cold water reservoir, said cold water reservoir being fluidly connected to the water inlet.

7. The dispenser according to claim 1, wherein the hot water reservoir has an overflow exit.

8. The dispenser according to claim 7, wherein the hot water reservoir overflow exit is fluidly connected to the cold water reservoir.

9. The dispenser according to claim 1, wherein the hot water reservoir has an at least partly translucent or transparent housing, such that the water can be observed from outside the dispenser.

10. The dispenser according to claim 9, further comprising a light source, wherein said light source is arranged to light the hot water reservoir.

11. The dispenser according to claim 1, wherein the heating device is a flow through heater.

12. The dispenser according to claim 1, wherein the dispenser is arranged to empty the warm water after use.

13. The dispenser according to claim 12, wherein the hot water reservoir contains an open connection with the ambient atmosphere such that no under-pressure can exist in the hot water reservoir.

14. The dispenser according to claim 1, wherein the height (hᵣ) of the hot water reservoir is higher than the equilibrium water height in said reservoir during use.

15. The dispenser according to claim 1, wherein the dispenser further comprises a flow meter arranged to measure the flow of water through the flow path, and a control unit arranged to control the pump based on at least the flow rate as measured by the flow meter, wherein the flow meter is located in the flow path between the water inlet and the hot water reservoir inlet opening.
